(19) United States
(12) Patent Application Publication
(10) Pub. No.: US 2009/0143107 A1
(43) Pub. Date: Jun. 4, 2009

(54) PORTABLE TERMINAL

(75) Inventor: Mihoko Hotta, Tokyo (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/067,006

(22) PCT Filed: Sep. 13, 2006
(86) PCT No.: PCT/JP2006/318197

§ 371 Date: Mar. 14, 2008

(30) Foreign Application Priority Data
Sep. 14, 2005 (JP) 2005-267192

(51) Int. Cl. H04M 1/00; G06F 3/033

(52) U.S. Cl. 455/566; 345/184

(57) ABSTRACT

While an attitude of a housing and an attitude change thereof are employed so as to operate an application, an input unit capable of giving a top priority to the application is provided at a predetermined position of the housing so as to provide a portable terminal having a superior operability.

The portable terminal 10 includes: an attitude detecting section 16 which detects one of an attitude and an attitude change of the housing 11; a control unit 17 which displays an image of an application on a display unit 13 based upon information acquired from a communication unit 14; and an output unit 18 capable of externally outputting image data and sound data of the application. In the portable terminal 10, the control unit 17 controls the application based upon the detection value obtained from the attitude detecting section 16. This portable terminal 10 includes input units 19 capable of operating at least a part of the application; and the input units 19 are provided on a top face 11E and a bottom face 11F, which are located adjacent to a front face 11A.

### TECHNICAL FIELD

The present invention relates to a portable terminal including attitude detecting section which detects an attitude of a housing and a change in attitudes thereof, the portable terminal displaying thereon an image of an application based upon a detection value acquired from the attitude detecting section.

### BACKGROUND ART

Conventionally, portable terminals capable of operating thereon such applications as games have been widely utilized. In these portable terminals, applications are initiated which are previously stored in storage units employed in housings of the portable terminals, applications downloaded via the Internet and the like are initiated, or applications are initiated which may be initiated in real time via the Internet and the like; images of these applications are displayed on display units provided on the housings; and also, while users view the display units, the users manipulate operation units equipped with various sorts of keys so as to operate the initiated applications.

In recent years, such portable terminals have been proposed in which attitudes of housings of these portable terminals and also changes in the attitudes thereof are sensed by acceleration sensors and angular velocity sensors, which are provided in the housings of the portable terminals, and then, the attitudes of the housings and the attitude changes of the housings are used so as to operate applications.

In accordance with these portable terminals, since the housings are operated in a similar manipulation manner to that of a joystick, for example, applications such as flight simulators can be intuitively operated (refer to non-patent publication 1).

Non-patent publication 1: Japanese magazine entitled “Digital Home Electronics are operable in swinging mode starting by Portable Telephones” of NIKKEI ELECTRONICS (Apr. 11, 2005), pages 51 to 60, published by NIKKEI BP publisher

### DISCLOSURE OF THE INVENTION

### Problems that the Invention is to Solve

On the other hand, in the non-patent publication 1, the attitudes of the housing and the attitude changes thereof are detected so as to be employed as to the basic operation of the application. However, the existing operation unit has been utilized as to delicate operations of the applications.

In the above-described operation units, the positions and the operation modes have been determined by giving a priority to the operability as the portable terminals. As a result, no specific care has not been applied with respect to a specific application. Thus, there is such a problem that superior operability of the application can be hardly achieved.

The present invention is made to solve the above-described conventional problem, and therefore, has an object to provide a portable terminal capable of achieving superior operability, since an attitude of a housing of the portable terminal and an attitude change thereof are employed in order to operate an application, and an input unit for giving a priority to the operations of the application is provided at a predetermined position of the housing.

### Means for Solving the Problems

A portable terminal according to the present invention includes: a housing in which an operation unit and a display unit are provided on a face of the housing; a communication unit contained in the housing, and capable of being communicated with another station; an attitude detecting section which is contained in the housing and detects one of an attitude and an attitude change of the housing; a control unit which runs an application and displays an image of the application on the display unit based upon information acquired from the communication unit; and an output unit capable of externally outputting image data and sound data of the application; wherein: the control unit controls the application based upon the detection value obtained from the attitude detecting section; the portable terminal includes an input unit capable of operating at least a part of the application; and the input unit is provided on a side face of the housing located adjacent to the face.

The application is operated based upon such an operation that any one of the attitude and the attitude change of the housing, a so-called “joystick operation” of the housing. As a consequence, a basic operation of the application can be carried out by the joystick operation of the housing.

Furthermore, the input unit is provided on the side face located adjacent to the front face to operate at least a part of the application. Since the input unit is provided for exclusively operating at least a part of the application, the input unit can be provided at such a position where the input unit can be easily operated while the application is executed, namely, at a predetermined position where the application is executed with a priority.

As a result, the delicate operations of the application may be carried out by operating the input unit.

Also, the present invention is featured by that when the image data and the sound data of the application are externally outputted from the output unit, at least a backlight of the display unit is turned OFF.

In this case, in the display unit, power consumption of the backlight (fluorescent lamp) is high. Accordingly, since the backlight of the display unit is turned OFF, the power saving effect can be improved.

It should be understood that the liquid crystal itself of the display unit may be driven. Alternatively, the driving operation of the display unit may be completely stopped.

Furthermore, the present invention is featured by that the communication unit can perform both a voice communication and a data communication in a parallel mode; when the voice communication is received while the application is running, a notification display for notifying the reception of the voice communication to a user is displayed on an external display apparatus which displays thereon the image of the application via the output unit; in case that the user refuses to receive the voice communication, the own station message is transmitted to a communication counter party, and thereafter, message recording process for recording a message of the communication counter party is performed; and in case that the user performs the voice communication, the control unit performs a telephone call reception process operation for controlling a sound volume of the external display apparatus.

When the voice communication is received while the application is running, the notification display for notifying the reception of the voice communication is displayed on the external display apparatus. In the case that the user refuses to receive the voice communication, the message of the own station is transmitted to the communication counter party, and thereafter, the telephone recording process for recording the message of the communication counter party is automatically carried out.

As a consequence, in such a case that the user refuses to receive the voice communication, the telephone recording process can be carried out under such a condition that the application is continuously performed.

On the other hand, in such a case that the user performs the voice communication, the telephone call receiving process for automatically adjusting the sound volume of the application is carried out. As a consequence, such a cumbersome operation for controlling the sound volume of the application by the user can be omitted, so that the user can quickly perform the verbal communication.

As previously explained, since both the telephone recording process and the telephone call receiving process are carried out, the usability can be improved.

### ADVANTAGE OF THE INVENTION

In accordance with the present invention, since the attitudes of the housing of the portable telephone and the attitudes change thereof are employed in order to operate the application, and the input unit for giving a priority to the operations of the application is provided at the predetermined position of the housing, the portable terminal has such an advantage that the superior operability can be achieved.

### BRIEF DESCRIPTION OF THE DRAWINGS

FIG. 1 is a perspective view for indicating a portable terminal according to a first embodiment of the present invention.

FIG. 2 is a block diagram for showing the portable terminal according to the first embodiment.

FIG. 3 is a flow chart for explaining process of the portable terminal according to the first embodiment from a commencement of a game until a telephone call is received.

FIG. 4 is a flow chart for explaining process of the portable terminal according to the first embodiment when the telephone call is received.

FIG. 5 is a perspective view for showing a portable terminal according to a second embodiment of the present invention.

FIG. 6A is a perspective view for showing a portable terminal according to a third embodiment of the present invention; and FIG. 6B is a diagram for explaining a using example of the portable terminal according to the third embodiment.

FIG. 7A is a perspective view for showing a modification 1 of the portable terminal according to the present invention; FIG. 7B is a perspective view for showing a modification 2 of the portable terminal according to the present invention; and FIG. 7C is a perspective view for showing a modification 3 of the portable terminal according to the present invention.

### DESCRIPTION OF REFERENCE NUMERALS AND SIGNS

10,40,50,60,70,80 portable terminal
11,41,51,61,71,81 housing
11A front face of housing
11E top face (side face adjacent to front face)
11F bottom face (side face adjacent to front face)
12A key
12 operation unit
13 display unit
14 communication unit
16 attitude detecting section
17 control unit
18 output unit
19 input unit
21 backlight
29 image of application
22 external display apparatus
25 user
24 pop-up display (notification display)
51B one side face (side face adjacent to front face)

### BEST MODE FOR CARRYING OUT THE INVENTION

Referring now to drawings, a description is made of portable terminals according to embodiments of the present invention.

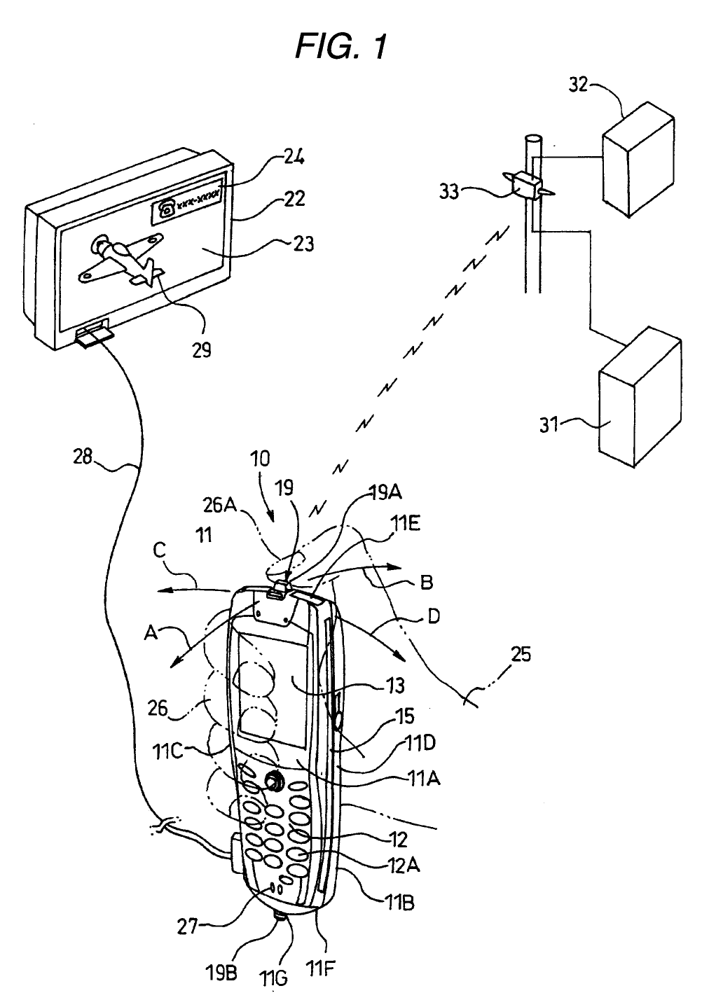

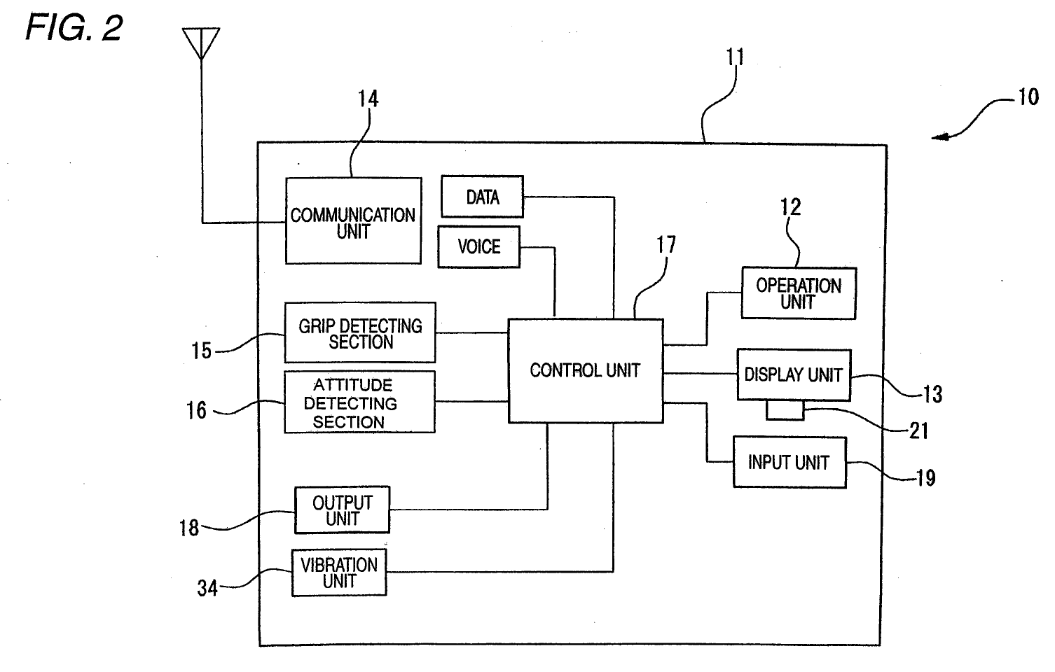

As shown in FIG. 1 and FIG. 2, a portable terminal 10 of a first embodiment includes: a housing 11 having an operation unit 12 and a display unit 13; a communication unit 14 contained in the housing 11 and communicatable with other stations; a grip detecting unit 15 which detects that the housing 11 is gripped; an attitude detecting section 16 which is contained in the housing 11 and detects any one of an attitude of the housing 11 and a change in attitudes thereof; a control unit 17 which initiates the application based upon information acquired from the communication unit 14 and displays an image of the application on the display unit 13; an output unit 18 being capable of externally outputting both image data and sound data of the application; and an input unit 19 being capable of operating at least a part of the application. The control unit 17 controls the application based upon detection values acquired from the attitude detecting section 16 and the input unit 19.

It should be understood that information derived from a server 31 and information derived from a telephone exchanging device 32 are transmitted via a base station 33 to the communication unit 14. As means for transmitting information from the base station 33 to the communication unit 14, there are usual telephone lines, wireless LANs (Local Area Networks), and the like.

The information derived from the server 31 is information for data communications such as an on-line game and the like. The information derived from the telephone exchanging device 32 is information for voice communications.

Since this portable terminal 10 is connected via an output cable 28 to an external display apparatus 22, an image 29 can be displayed on a display unit 23 of the external display apparatus 22, and further, sound is outputted from the external display apparatus 22.

It is so assumed that in the embodiment, the application is a game, and the image 29 of the game is an airplane.

Moreover, while the portable terminal 10 outputs image data and sound data of the application from the output unit 18, at least the backlight 21 of the display unit 13 is turned OFF. Since the backlight 21 of the display unit 13 is turned OFF, a power saving effect may be achieved.

It should also be noted that the liquid crystal itself of the display unit 13 may be driven, or alternatively driving operation of the display unit 13 may be completely stopped.

In addition, in the portable terminal 10, the communication unit 14 is capable of executing both a voice communication and a data communication in a parallel mode; when the voice communication is received while an application is running, a pop-up display (notification indication) 24 for notifying the reception of the voice communication to a user 25 is displayed on the external display apparatus 22 via the output unit 18, which displays the image of the application; in such a case that the user 25 refuses to receive the voice communication, the own station message is sent to a communication counter party, and thereafter, a telephone recording process operation for recording a message sent from the communication counter party is performed; and in such a case that the user 25 establishes the voice communication, the control unit 17 performs a telephone call receiving process operation for controlling a sound volume of the external display apparatus 22.

As previously described, it should also be noted that the voice communication corresponds to the communication transmitted from the telephone exchanging device 32, and the data communication corresponds to the communication transmitted from the server 31.

The housing 11 is formed in a substantially rectangular body by a front face 11A made in a substantially rectangular shape; a rear face 11B made in a substantially rectangular shape; a left side face 11C and a right side face 11D; and a top face 11E and a bottom face 11F. The bottom face 11F is formed in a tapered shape toward a center 11G of the housing 11.

Since the bottom face 11F is formed in the tapered shape toward the center 11G, under such a condition that the portable terminal 10 is stood up on a floor, or on a desk as shown in FIG. 1, this portable terminal 10 can be moved in a swinging manner along, for instance, a direction indicated by arrows A and B, and another direction indicated by arrows C and D.

In this housing 11, the display unit 13 is provided at an upper half portion of the front face 11A, the operation unit 12 is provided at a lower half portion thereof, and a microphone 27 is provided below the operation unit 12. A large number of keys 12A are provided on the operation unit 12.

Furthermore, the input units 19 (concretely speaking, upper depression switch 19A and lower depression switch 19B) are provided on both the top face (side face) 11E and the bottom face (side face) 11F, which are located adjacent to the front face 11A of the housing 11.

The grip detecting sections 15 are provided on the left side face 11C and the right side face 11D (note that the grip detecting section 15 of left side face 11C is not shown), and correspond to such grip switches which detect that the user 25 grips the housing 11 by his/her hand 26 and transmits a detection signal to the control unit 17.

The control unit 17 recognizes a starting time of an application such as a game, an end time of the application, or such an operation that the application such as the game is running based upon the above-described detection signal.

As this grip detecting section 15, optical sensors are employed as one example. As other examples, depression pressure sensors may be alternatively employed.

Also, the optical sensors functioning as the grip detecting section 15 may be provided on the display unit and the keys 12A of the operation unit 12.

Moreover, the depression pressure sensors functioning as the grip detecting section 15 may be alternatively provided on the front face and the rear face of the housing 11, or may be alternatively provided on the keys 12A of the operation unit 12.

The attitude detecting section 16 detects any one of an attitude and an attitude change of the housing 11, and as one example, an direction sensor (acceleration sensor) is employed.

As represented in FIG. 1, under such a condition that the housing 11 is stood up on the floor, or on the desk, when the housing 11 is moved in the swing manner along the direction indicated by the arrows A-B, or along the direction indicated by the arrows C-D, the attitude detecting section 16 detects an inclination of the housing 11 so as to transmit a detection signal to the control unit 17.

As a result, the application can be operated based upon such an operation that any one of the attitude and the attitude change of the housing 11, a so-called “joystick operation” of the housing 11.

As a consequence, a basic operation of the application can be carried out by the joystick operation of the housing 11.

Concretely speaking, in response to the joystick operation of the housing 11, an inclination, a circle, a speed, and the like as to the airplane which is displayed as the image 29 on the display unit 23 of the external display apparatus 22 are controlled.

It should also be understood that since an angular velocity sensor is equipped as the attitude detecting section 16, actions when the housing 11 is rotated around an axis may be detected.

Since the angular velocity sensor is employed, the operating items of the housing 11 in such a joystick manner are increased, so that user friendly operations may be improved.

This detection signal is utilized as a switch for operating the application. As a result, not only such an intuitive operability that the housing 11 is inclined may be obtained, but also the portable terminal 10 may be similarly used for such users as a handicapped person and an elder person, who can hardly push small buttons.

It should also be noted that the housing 11 may be used not only under such a condition that the housing 11 is stood up on the floor, or on the desk, but also, may be used for a user who stretches himself/herself out on a bed. In other words, since such an attitude that the housing 11 falls sideways is initialized as a reference condition, the housing 11 may be operated in a similar manner to the operations obtained under such a condition that the housing 11 is stood up on the floor, or the desk.

The input unit 19 is employed in order to operate at least a part of the application. As one example, an upper depression button switch 19A is provided on a center of the top face 11E, and a lower depression button switch 19B is provided on a center of the bottom face 11F.

Although such an exemplification is indicated in which the input units 19 are provided on both the top face 11E and the bottom face 11F as the side faces which are located adjacent to the housing 11, the input units 19 may be alternatively provided on the left side face 11C and the right side face 11D as another example.

The upper depression switch 19A is depressed by a thumb 26A, whereas the lower depression switch 19B is operated by depressing the housing 11, for instance, under such a condition that the housing 11 is stood up on the floor, or the desk.

Other than the upper and lower depression button switches 19A and 19B, as the input unit 19, for instance, a slide switch, a slid pad, a trigger, and a pressure sensitive switch may be alternatively employed.

In the first embodiment, for the sake of convenience, it is so assumed that since the upper depression button switch 19A is operated, at least a partial operation of the application (concretely speaking, delicate operation of application) is executed. A delicate operation of the application implies that delicate functions of the application are switched.

Concretely speaking, since the upper depression button switch 19A is operated, the airplane shoots a gun, which is being displayed as the image 29 on the display unit 23 of the external display apparatus 22.

On the other hand, since the lower depression switch 19B is operated, at least a partial operation of the application (concretely speaking, starting operation and ending operation of application) is performed.

This depression button switch 19B may be employed so as to detect up/down actions of the housing 11. Since up/down action signal is transmitted to the control unit 17, the delicate functions of the application may be switched.

As previously described, since the input unit 19 (upper/lower depression button switches 19A and 19B) is provided which exclusively operates at least a part of the application, the input unit 19 may be provided at such a position where the input unit 19 can be easily operated while the application is executed, namely, at a predetermined position where the application is executed with a priority.

As a result, the delicate operations of the application may be carried out by operating the input unit 19.

In accordance with the portable terminal 10 of the first embodiment, since the attitude detecting section is provided, the housing 11 can be operated in the joystick operation mode, and further, since the input unit 19 for giving the priority to the operation of the application is provided at the predetermined position of the input unit 19, the superior operability can be achieved.

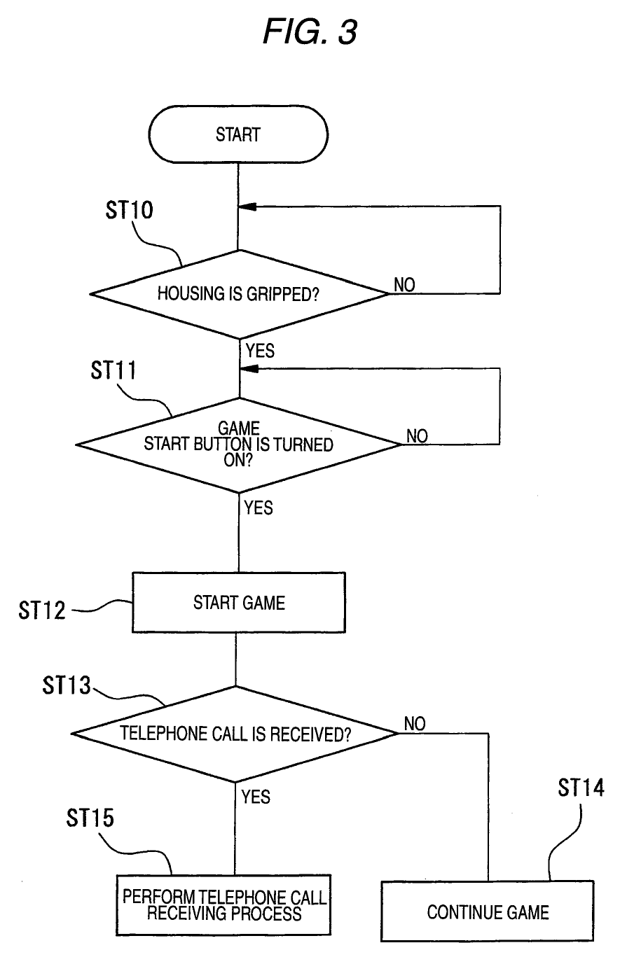

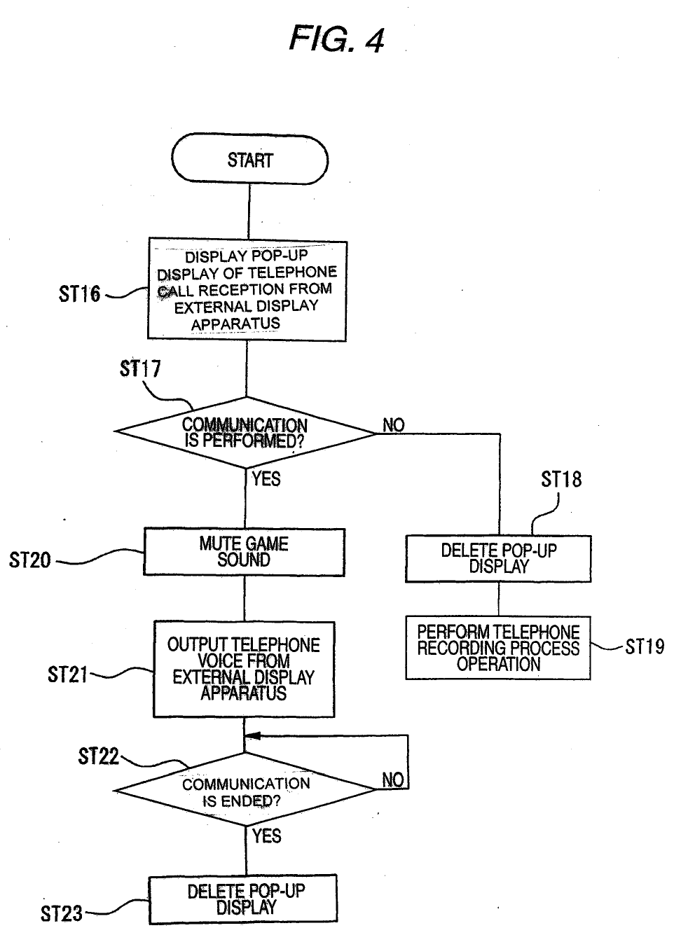

Next, a description is made of operations executed in the portable terminal 10 of the first embodiment with reference to flow charts of FIG. 3 and FIG. 4. It should also be noted that in the descriptions of the operations, a game is exemplified as the application.

Firstly, process operations defined from the commencement of the game to the reception of a telephone call will now be described with reference to the flow chart of FIG. 3.

ST10; A determination is made whether or not the user 25 has gripped the housing 11 by his/her hand 26. When the user 25 does not grip the housing 11, the process operation is returned to the step ST10. When the user 25 grips the housing 11, the process operation is advanced to a step ST11.

ST11; A determination is made whether or not a game start button is turned ON. When the game start button is turned OFF, the process operation is returned to the step ST11. When the game start button is turned ON, the process operation is advanced to a step ST12.

As the game start button, the lower depression button 19B is employed. That is to say, under such a condition that the lower depression button switch 19B abuts on, for instance, the floor, or the desk, the lower depression button switch 19B is depressed, so that the game start button is turned ON.

ST12; The game is commenced.

In other words, an airplane is displayed as the image 29 of the game on the display unit 23 of the external display apparatus 22.

While the user views the image 29, the user moves the housing 11 in the swing manner along the direction indicated by the arrows A-B, and along the direction indicated by the arrows C-D, and operates the upper depression switch 19A so as to play the game.

It should also be understood that since a vibrator (vibration unit) 34 provided in the housing is run in connection with the game, attendant feelings may be increased.

ST13; A determination is made whether or not a telephone call is received. When the telephone call is not received, the process operation is advanced to a step ST14. When the telephone call is received, the process operation is advanced to a step ST15.

When the telephone call is received, the vibrator (vibration unit) 34 is initiated so as to notify the reception of the telephone call to the user.

It should also be noted that it is preferable to design that a vibration frequency of the vibrator 34 during the game play is different from a vibration frequency of the vibrator 34 when the telephone call is received.

ST14; The game is continuously played.

ST15; A process operation for receiving a telephone call is executed.

Next, a description is made of the process operations executed when the telephone call is received based upon a flow chart shown in FIG. 4.

ST16; The reception of the telephone call is displayed in the pop-up display (notification display) 24 on the display unit 23 of the external display apparatus 22.

ST17; A determination is made whether or not a telephone communication is established. When the telephone communication is established, the process operation is advanced to a step ST18. When the telephone communication is not established, the process operation is advanced to a step ST20.

When the telephone communication is not established, under such a condition that the lower depression button switch 19B abuts on, for example, the floor, or the desk, the condition where the housing 11 has been depressed is continued.

On the other hand, when the telephone communication is established, the housing 11 is brought up so as to turn OFF the lower depression button 19B.

ST18; The pop-up display 24 is deleted from the display unit 23.

ST19; A telephone recording process is carried out.

ST20; The game sound of the external display apparatus 22 is turned OFF, or the game sound is decreased.

ST21; The telephone communication voice is outputted from the external display apparatus 22.

It should also be noted that since a microphone is not provided in the external display apparatus 22, the microphone 27 of the housing 11 is used while the telephone communication is established.

ST22; A determination is made whether or not the telephone communication is ended. When the telephone communication is not yet ended, the process operation is returned to the step ST22. When the telephone communication is ended, the process operation is advanced to a step ST23.

ST23; The pop-up display 24 is deleted from the display unit 23.

As previously explained with reference to the flow charts shown in FIG. 3 and FIG. 4, when the voice communication is received while the application is running, the pop-up display (notification display) for notifying the reception of the voice communication is displayed on the display unit 23 of the external display apparatus 22. In the case that the user refuses to receive the voice communication, the message of the own station is transmitted to the communication counter party, and thereafter, the telephone recording process operation for recording the message of the communication counter party is automatically carried out.

As a consequence, in such a case that the user refuses to receive the voice communication, the telephone recording process operation can be carried out under such a condition that the application is continuously performed.

On the other hand, in such a case that the user establishes the voice communication, a telephone call receiving process operation for automatically controlling the sound volume of the application is carried out. As a consequence, such a cumbersome operation for controlling the sound volume of the application by the user can be omitted, so that the user can quickly perform the voice telephone communication.

As previously explained, since both the telephone recording process operation and the telephone call receiving process operation are carried out, the user friendly operability of the portable terminal 10 can be improved.

In the flow charts of FIG. 3 and FIG. 4, the description has been made of the process operations when the telephone call is received while the user plays the game. Alternatively, a similar process operation may be carried out while an electronic mail and a Web site are viewed by opening a small window on the display unit 23 of the external display apparatus 22.

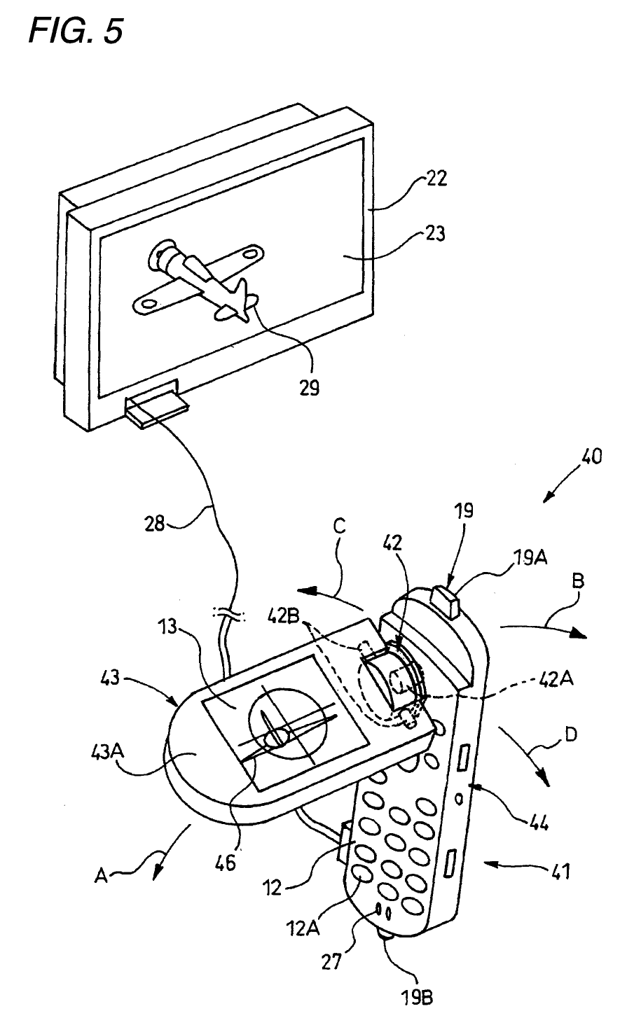

Next, a description is made of a second embodiment and a third embodiment with reference to FIG. 5 to FIG. 7. It should be understood that the same reference numerals shown in the portable terminal 10 of the first embodiment will be employed as those for denoting the same, or similar structural elements in the second to third embodiments, and descriptions thereof will be omitted.

### SECOND EMBODIMENT

A portable terminal 40 of the second embodiment represented in FIG. 5 is constructed in such a manner that instead of the housing 11 of the first embodiment, a housing 41 is freely bent via a coupling portion 42, and other structural elements of the portable terminal 40 are similar to those of the portable terminal 10 of the first embodiment.

That is, the housing 41 of the portable terminal 40 is arranged in the freely bendable manner by coupling an upper housing 43 via the coupling portion 42 to a lower housing 44 in a freely openable/closable manner.

The upper housing 43 is formed in a substantially rectangular shape, and the display unit 13 is provided on an inner side face 43A.

The lower housing 44 includes the operation unit 12 made of a plurality of operation keys 12A, and the microphone 27 is provided below the operation unit 12.

The coupling portion 42 contains a first supporting shaft 42A and a second supporting shaft 42B, which are mutually intersected with each other in a perpendicular manner. The upper housing 43 and the lower housing 44 are freely rotatably coupled to each other by the first and second supporting shafts 42A and 42B.

In other words, the coupling portion 42 rotatably supports both the upper housing 43 and the lower housing 44 under a folded condition and under an opened condition while the first supporting shaft 42A is employed as an axis, and furthermore, the coupling portion 42 supports the upper housing 43 in a circlable manner while the second supporting shaft 42B is set as an axis.

As a consequence, as shown in FIG. 5, since the upper housing 43 is arranged under such a condition that this upper housing 43 is bent at an angle of approximately 90 degrees with respect to the lower housing 44, and further is inclined, the display unit 13 can be arranged at a position where the user can easily view the display unit 13.

An enemy aircraft 46 viewed from the user is displayed on the display unit 13, and also, the airplane 29 of the user 25 is displayed on the display unit 23 of the external display apparatus 22.

As a result, while viewing the enemy aircraft 46 on the display unit 13, the user can perform sighting operation at his/her hand, so that superior operability can be achieved.

In addition, in accordance with the portable terminal 40 of the second embodiment, a similar effect to that of the portable terminal 10 of the first embodiment can be obtained.

### THIRD EMBODIMENT

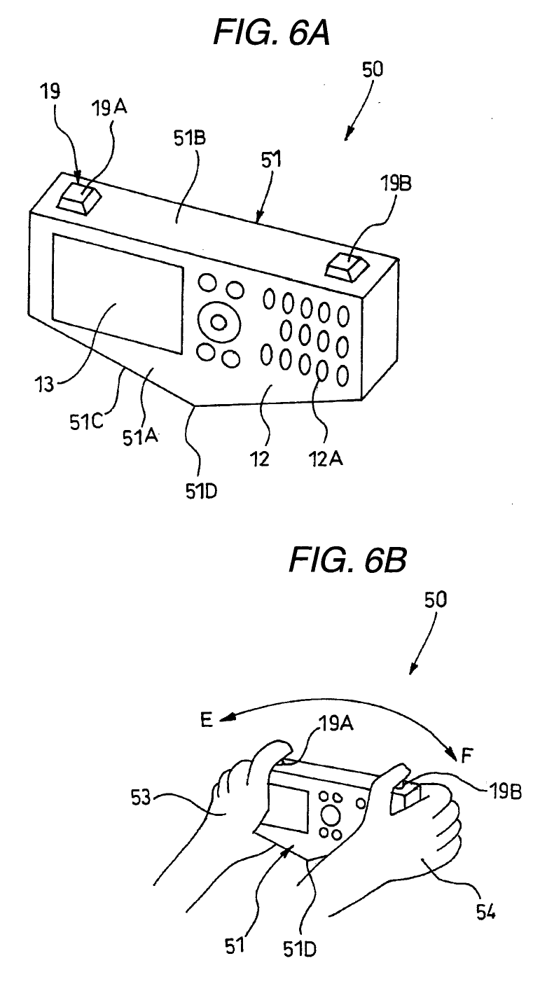

A portable terminal 50 of the third embodiment represented in FIG. 6A and FIG. 6B is constructed in such a manner that instead of the housing 11 of the first embodiment, a housing 51 is employed, and other structural elements of the portable terminal 50 are similar to those of the portable terminal 10 of the first embodiment.

Under such a condition that the housing 51 is arranged in a lateral direction, one side face (side face) 51B located adjacent to a front face 51A is positioned on the upside, and the other side face 51C located adjacent to the front face 51A is positioned on the downside.

The input units 19 (concretely speaking, depression button switches 19A and 19B) are provided on both edge portions of one side face 51B.

The other side face 51C is formed in a tapered shape and is directed to a center 51D.

Since the other side face 51C is formed in the tapered shape and directed to the center 51D, under such a condition that the center 51D is mounted on the floor, or the desk, both the edge portions of the housing 51 are gripped by a left hand 53 and a right hand 54, and can be moved in a swing manner along, for example, a direction indicated by arrows E-F.

In accordance with the portable terminal 50, the depression button switches 19A and 19B can be manipulated by the left hand 53 and the right hand 54 respectively, so that superior operability can be achieved.

In addition, in accordance with the portable terminal 50 of the third embodiment, a similar effect to that of the portable terminal 10 of the first embodiment can be obtained.

### Modifications

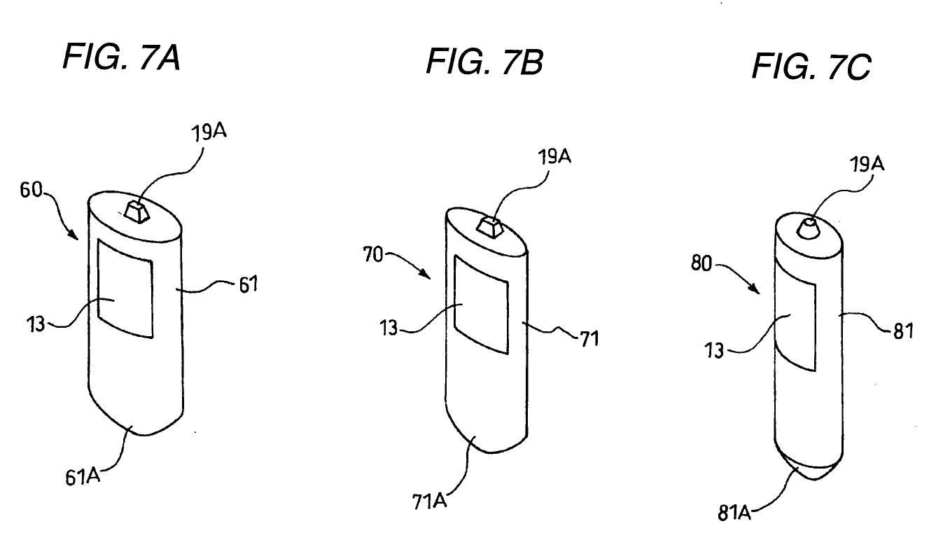

FIG. 7A to FIG. 7C indicate modifications 1 to 3.

A portable terminal 60 of the modification 1 shown in FIG. 7A is arranged in such a manner that an outer circumference of a housing 61 is formed in an elliptical shape, and a bottom portion 61A thereof is formed in a boat shape. Other structural elements of the portable terminal 60 are similar to those of the portable terminal 10 of the first embodiment.

Since the outer circumference of the housing 61 is formed in the elliptical shape, the portable terminal 60 can be easily gripped, and since the bottom portion 61A is formed in the boat shape, the housing 61 can be easily inclined.

In addition, in accordance with the portable terminal 60 of the modification 1, a similar effect to that of the portable terminal 10 of the first embodiment can be achieved.

A portable terminal 70 of the modification 2 shown in FIG. 7B is arranged in such a manner that an outer circumference of a housing 71 is formed in an elliptical shape, and a bottom portion 71A thereof is formed in a semicylindrical shape. Other structural elements of the portable terminal 70 are similar to those of the portable terminal 10 of the first embodiment.

Since the outer circumference of the housing 71 is formed in the elliptical shape, the portable terminal 70 can be easily gripped, and since the bottom portion 71A is formed in the semicylindrical shape, the housing 71 can be easily inclined.

In addition, in accordance with the portable terminal 70 of the modification 2, a similar effect to that of the portable terminal 10 of the first embodiment can be achieved.

A portable terminal 80 of the modification 3 shown in FIG. 7C is arranged in such a manner that an outer circumference of a housing 81 is formed in a circular shape, and a bottom portion 81A thereof is formed in a circular cone shape. Other structural elements of the portable terminal 80 are similar to those of the portable terminal 10 of the first embodiment.

Since the outer circumference of the housing 81 is formed in the circular shape, the portable terminal 80 can be easily gripped, and since the bottom portion 81A is formed in the circular cone shape, the housing 81 can be easily inclined.

In addition, in accordance with the portable terminal 80 of the modification 3, a similar effect to that of the portable terminal 10 of the first embodiment can be achieved.

The present patent application is based upon and claims the benefit of priority of Japanese patent application (JP-A-2005-267192) filed on Sep. 14, 2005, the contents of which are hereby incorporated by reference into this patent application.

### INDUSTRIAL APPLICABILITY

The present invention is suitably applied to a portable terminal which is equipped with an attitude detecting section which detects an attitude of a housing and an attitude change thereof, and displays an image of an application based upon a detection value obtained from the attitude detecting section.

1. A portable terminal, comprising:
a housing in which an operation unit and a display unit are provided on a front face of the housing;
a communication unit contained in the housing, and communicating with an external apparatus;
an attitude detecting section which is contained in the housing and detects one of an attitude and an attitude change of the housing;
a control unit which runs an application and displays an image of the application on the display unit based upon information acquired from the communication unit; and
an output unit capable of externally outputting image data and sound data of the application; wherein:
the control unit controls the application based upon the detection value obtained from the attitude detecting section;
the portable terminal includes an input unit capable of operating at least a part of the application; and
the input unit is provided on a side face of the housing located adjacent to the front face.

2. The portable terminal as claimed in claim 1, wherein when the image data and the sound data of the application are externally outputted from the output unit, at least a backlight of the display unit is turned OFF.

3. The portable terminal as claimed in claim 1 wherein:
the communication unit can perform both a voice communication and a data communication in a parallel mode;
when the voice communication is received while the application is running, a notification display for notifying the reception of the voice communication displayed on an external display apparatus which displays thereon the image of the application via the output unit;
in case that a user does not answer the voice communication, the own station message is transmitted to a communication counter party, and thereafter, message recording process for recording a message of the communication counter party is performed; and
in case that the user answers the voice communication, the control unit performs a call reception process operation for controlling a sound volume of the external display apparatus.
